(19) United States
(12) Patent Application Publication
(10) Pub. No.: US 2014/0155557 A1
(43) Pub. Date: Jun. 5, 2014

(54) NOVEL DURABLE, HYDROLYSIS-STABLE BIO-BASED PLASTICS BASED ON POLYHYDROXYALKANOATE (PHA), METHOD FOR PRODUCING SAME, AND USE THEREOF

(71) Applicants: Andrea Fruth, Wiesbaden (DE); Andreas Krug, Mannheim (DE); Bernd Wiloth, Ketsch (DE)

(72) Inventors: Andrea Fruth, Wiesbaden (DE); Andreas Krug, Mannheim (DE); Bernd Wiloth, Ketsch (DE)

(73) Assignee: RHEIN CHEMIE RHEINAU GMBH, Mannheim (DE)

(21) Appl. No.: 14/115,492

(22) PCT Filed: May 2, 2012
(86) PCT No.: PCT/EP2012/058026

§ 371 Date: Jan. 13, 2014

(30) Foreign Application Priority Data
May 6, 2011 (EP) 11165137.8
Nov. 25, 2011 (EP) 11190827.3

(51) Int. Cl. C08L 67/04

(52) U.S. Cl. CPC C08L 67/04
USPC 525/450

(57) ABSTRACT

The invention relates to the invention provides innovative long-lived and hydrolysis-stable biobased plastics based on polyhydroxyalkanoate (PHA) and featuring sufficient melt stability, a method for producing them and their use.

The invention relates to innovative long-lived and hydrolysis-stable biobased plastics based on polyhydroxyalkanoate (PHA) and featuring sufficient melt stability, a method for producing them and their use.

Biobased plastics, known as biopolymers, are more environmentally sustainable materials than petrochemically based plastics, on account of the biobased raw materials employed. Particularly in respect of environmental protection and of the onset of climatic warming, biobased plastics have acquired increasing importance not only in the packaging sector but also in the production of long-lived and industrial plastics products. In order, however, to make biobased materials based on polyhydroxyalkanoates competitive in comparison to conventional and established materials, optimizations are still necessary in many cases in the production and processing of the material.

Biobased plastics are composed, for example, of an aliphatic polyester resin which is produced by direct fermentative preparation from starch, sugar, carbohydrates, vegetable oil or fats.

Biobased plastics have the great advantage that they are very eco-friendly. In the area of industrial applications, from among the group of biopolymers, polyhydroxyalkanoates (PHA) in particular have the advantage that they possess, for example, a greater heat distortion resistance in comparison to polylactic acid (PLA). This allows the production of long-lived articles which cannot be employed made from polylactic acid on account of the low softening point, examples of such articles being kettles and hairdryers. Furthermore, polyhydroxyalkanoates exhibit very little shrinkage in manufactured products, thereby allowing product geometries which are unrealizable with conventional polymers.

Both polylactic acid and polyhydroxyalkanoates belong to the class of aliphatic polyesters and are both susceptible to polymer degradation during processing and in the course of the application. The degradation mechanism in the case of polylactic acid runs along the classic path of an ester hydrolysis, where the action of acids or bases in the presence of water is accompanied by a cleavage of the ester bond in the polylactic acid, thereby generating new hydroxyl groups and carboxyl groups.

The new carboxyl groups result in hydrolysis of further ester groups in the polylactic acid polymer—that is, the process proceeds autocatalytically. Ester cleavage in the polylactic acid leads, consequently, to polymer degradation and hence to a reduction in the lifetime of the polylactic acid, and also to an unstable operational regime.

In comparison to polylactic acid, however, the product class of the polyhydroxyalkanoates is far less sensitive to hydrolysis. This difference in susceptibility to hydrolysis is a result of the different degradation mechanism. In the case of polyhydroxyalkanoates, in contrast to polylactic acid, a different degradation mechanism, that of a β-elimination, is predominant. This β-elimination results in the cleavage of the polyhydroxyalkanoate polymer chain with formation of unsaturated polymer fragments; see Yoshihiro Aoyagi, et al., Polymer Degradation and Stability 76, 2002, 53-59.

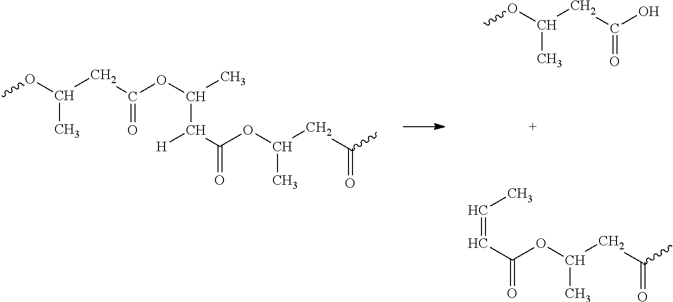

In comparison to polylactic acid, the hydrolytic degradation of polyhydroxyalkanoates plays a minor part, but may likewise occur, since PHAs are also aliphatic polyesters. In spite of the different degradation mechanism, polyhydroxyalkanoates have the disadvantage that for long-lived and industrial applications they do not possess sufficient stability to hydrolysis, and, moreover, have poor processing properties, as manifested in a sharp rise in the melt volume rate (MVR). It is therefore necessary to look for a possibility of achieving stabilization of PHA during processing and during application, in spite of the combination of the largely prevailing β-elimination and the hydrolysis which nevertheless likewise occurs.

Attempts have been made to solve this problem through the addition of a wide variety of additives. For example, the abstract of JP-A 2008 303 286 describes the use of 0.5% by weight of a polymeric carbodiimide in polyhydroxyalkanoates. In relation to the stability to hydrolysis, however, no satisfactory result is achieved here. The same applies to WO 2009119512, which cites the use of a polycarbodiimide from mixtures of polybutylene succinate and also blends of polybutylene succinate with polylactic acid and polyhydroxyalkanoates. The aliphatic polycarbodiimide used here is employed for the purpose of stabilizing the polybutylene succinate. Here as well, however, no sufficient hydrolysis resistance is obtained.

EP-A 1 627 894 describes the use of diisopropylphenylcarbodiimide as a hydrolysis inhibitor in aliphatic polyester resins. In terms of the processing properties and inhibition of hydrolysis, however, no satisfactory outcome is achieved.

In EP-A 10172530 the use of a combination of a monomeric and oligomeric carbodiimide is described. While this does lead to an improvement in the inhibition of hydrolysis and in processing, this outcome is nevertheless still not sufficient in terms of the hydrolysis inhibition effect in numerous concentration ranges.

Surprisingly it has now been found that the biobased plastics of the invention from the class of the polyhydroxyalkanoates, comprising at least >0.5% by weight of oligomeric and/or polymeric aromatic and/or araliphatic oligomeric carbodiimide, fulfill this object.

The present invention accordingly provides biobased plastics comprising a combination of at least one polyhydroxyalkanoate and at least 0.5% by weight, preferably 0.7% and 4% by weight, more preferably 1%-2.5% by weight, very preferably 1% to 2.0% by weight, of at least one oligomeric and/or polymeric aromatic and/or araliphatic carbodiimide, and in one preferred embodiment of the invention this combination consists substantially of polyhydroxyalkanoate and carbodiimide.

Further additives are, for example, stabilizers, such as antioxidants, plasticizers, impact modifiers, flame retardants and fillers.

The biobased plastics in the sense of the invention are preferably polyhydroxyalkanoates which can be produced by direct fermentative preparation from starch, sugar, carbohydrates, vegetable oil or fats.

Polyhydroxyalkanoates are preferably compounds of the structural formula (I)

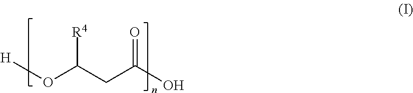

where n>10 and R⁴=C₁- to C₁₄-alkyl. Particularly preferred are polyhydroxybutyrate (PHB), polyhydroxyvalerate (PHV), polyhydroxybutyrate valerate (PHBV), polyhydroxyhexonate (PHH), polyhydroxyoctanoate (PHO), polyhydroxybutyrate hexanoate (PHBH), and mixtures thereof.

The polyhydroxyalkanoates particularly preferred as biobased plastics are available commercially, as for example under the name Mirel from the company Telles or as Enmat from the company Tianan, or can be prepared by the methods familiar to the skilled person, such as by fermentation, for example.

As oligomeric and/or polymeric carbodiimides it is possible to use all known carbodiimides of the formula (II)

R′—(—N═C═N—R′″—)ₘ—R″ (II),

in which

R′″ is an aromatic and/or araliphatic radical and for m>1, R′″ within the molecule is identical or different and in the case of different combinations, each of the aforementioned radicals may be combined as desired with one another,

R′″ in the case of an aromatic or an araliphatic radical may carry no or, in at least one ortho-position to the aromatic carbon atom that carries the carbodiimide group, may carry aliphatic and/or cycloaliphatic substituents having at least 2 carbon atoms, preferably branched or cyclic aliphatic radicals having at least 3 carbon atoms, more particularly isopropyl groups, which may also carry heteroatoms, such as, for example, N, S and/or O, or else imidazolyl,

R′=C₁-C₁₈-alkyl, C₅-C₁₈-cycloalkyl, aryl, C₇-C₁₈-aralkyl, —R—NHCOS—R¹, —R—COOR¹, —R—OR¹, —R—N(R¹)₂, —R—SR¹, —R—OH, —R—NH₂, —R—NHR¹, —R-epoxy, —R—NCO, —R—NHCONHR¹, —R—NHCONR¹R² or —R—NHCOOR³, where R=aromatic, aliphatic, cycloaliphatic and/or araliphatic radical,

R″═H, —N═C═N-aryl, —N═C═N-alkyl, —N═C═N-cycloalkyl, —N═C═N-aralkyl, —NCO, —NHCONHR¹, —NHCONR¹R², —NHCOOR³, —NHCOS—R¹, —COOR¹, —OR¹, —N(R¹)₂, —SR¹, —OH, —NH₂, —NHR¹,

and in R′ and R″, independently of one another, R¹ and R² are identical or different and are a C₁-C₂₀-alkyl, C₃-C₂₀-cycloalkyl, aryl, C₇-C₁₈-aralkyl radical, oligo-/polyethylene glycols and/or oligo-/propylene glycols, and R³ has one of the definitions of R¹ or is a polyester radical or a polyamide radical, and m corresponds to an integer from 2 to 5000; in the case of oligomeric carbodiimides, m corresponds to an integer from 2 to 5, and in the case of polymeric carbodiimides, m corresponds to an integer of >5,

and/or of the formula (III)

R′—[—(—N═C═N—Y—)ₚ—(—B—)_{q}—]ₒ—X (III),

where

Y=arylene, C₇-C₁₈-aralkylene,

p=an integer from 1 to 500, preferably 1 to 100,

B=—NH—CO—NH—Z—, —NH—COO—Z—, —NH—COS—Z—,

q=an integer from 1 to 500, preferably 1 to 100,

o=an integer from 1 to 500, preferably 1 to 100, and

either p or o must be >1.

X═H, —OH, —SH, —NH₂, —OR¹, —N(R¹)₂, —SR¹, —NHR¹, NR¹R², —OCO—NH—R′, NHCO—, —NH—R′, —S—CO—NH—R′, R′=C₁-C₁₈-alkyl, C₅-C₁₈-cycloalkyl, aryl, C₇-C₁₈-aralkyl, —R′″—NH—COS—R¹, —R′″—COOR¹, —R′″—OR¹, —R′″—N(R¹)₂, —R′″—SR¹, —R′″—OH, —R′″—NH₂, —R′″-epoxy, —R′″—NCO, —R′″—NHCONR¹, —R′″—NHCONR¹R² or —R′″—NH—COOR³, where

R¹ and R² are identical or different and are a C₁-C₂₀-alkyl, C₃-C₂₀-cycloalkyl, aryl, or C₇-C₁₈-arylkyl radical, or are oligo-/polyethylene glycols and/or oligo-/propylene glycols, and R³ has one of the definitions of R¹ or is a polyester radical or a polyamide radical,

Z═Y, polyesters, polyethers, polyamides, and R′″ is an aromatic and/or araliphatic radical.

For the purposes of the invention, the term “araliphatic” refers to an optionally substituted aromatic radical that is linked via an alkyl group, such as, for example, —(CH₂)ᵢ—, —(CH₃)₂—, —CH(C₁-C₁₈-alkyl), preferably —CH₂—, —C₂H₄—, —C₃H₆—, —C(CH₃)₂—, with i=1-10.

Particular preference is given here to aromatic oligomeric and/or polymeric carbodiimides of the aforementioned formula (I) with m≧2.

It is likewise preferred for the polymeric and/or oligomeric carbodiimide to comprise compounds of the formula (II) in which R′″ corresponds to 1,3-substituted-2,4,6-triisopropylphenyl and/or 1,3-bis(1-methyl-1-isocyanatoethyl)benzene and/or tetramethylxylylene derivatives and/or 2,4-substituted tolylene and/or 2,6-substituted tolylene and/or mixtures of 2,4- or 2,6-substituted tolylene.

The aforementioned carbodiimides are commercial compounds, which are available commercially, for example, from Rhein Chemie Rheinau GmbH under the trade names Stabaxol® P (N—C—N content: 12.5-13.5%), Stabaxol® P 100 (N—C—N content: 12.5-13.5%) and Stabaxol® P 400 (N—C—N content: 12.5-13.5%).

Also possible as well is the preparation of the carbodiimides by the methods described in Angewandte Chemie 74 (21), 1962, pp. 801-806 for example, or by the condensation of diisocyanates with elimination of carbon dioxide at elevated temperatures, e.g. at 40° C. to 200° C., in the presence of catalysts. Suitable methods are described in DE-B-11 56 401 and in DE-B-11 305 94. Examples of catalysts which have been found appropriate include strong bases or phosphorus compounds. Preference is given to using phospholene oxides, phospholidines or phospholine oxides, and also the corresponding sulfides. As catalysts it is possible, furthermore, to use tertiary amines, basic metal compounds, metal salts of carboxylic acids, and non-basic organometallic compounds.

For preparing the carbodiimides and/or polycarbodiimides used, all isocyanates are suitable, with preference being given in the context of the present invention to the use of carbodiimides and/or polycarbodiimides that are based on aromatic isocyanates substituted by C₁- to C₄-alkyl, such as, for example, 2,6-diisopropylphenyl isocyanate, 2,4,6-triisopropylphenyl 1,3-diisocyanate, 2,4,6-triethylphenyl 1,3-diisocyanate, 2,4,6-trimethylphenyl 1,3-diisocyanate, 2,4′-diisocyanatodiphenylmethane, 3,3′,5,5′-tetraisopropyl-4,4′-diisocyanatodiphenylmethane, 3,3′,5,5′-tetraethyl-4,4′-diisocyanatodiphenylmethane, tetramethylxylene diisocyanate, 1,5-naphthalene diisocyanate, 4,4′-diphenylmethane diisocyanate, 4,4′-diphenyldimethylmethane diisocyanate, 1,3-phenylene diisocyanate, 1,4-phenylene diisocyanate, 2,4-tolylene diisocyanate, 2,6-tolylene diisocyanate, a mixture of 2,4-tolylene diisocyanate and 2,6-tolylene diisocyanate, xylylene diisocyanate, tetramethylxylylene diisocyanate, 2,6-diisopropylphenylene isocyanate and 1,3,5-triisopropylbenzene 2,4-diisocyanate or mixtures thereof, or are based on substituted aralkyls, such as 1,3-bis(1-methyl-1-isocyanatoethyl)benzene. It is particularly preferred if the carbodiimides and/or polycarbodiimides are based on 2,4,6-triisopropylphenyl 1,3-diisocyanate and/or 2,6-diisopropylphenylene isocyanate and/or tetramethylxylylene diisocyanate.

Furthermore, polycarbodiimides, if prepared from isocyanates, may also contain reactive NCO groups and monomeric isocyanates with complex-type bonding.

In a further preferred embodiment of the present invention, the total amount of carbodiimides, based on the plastic, is greater than 0.5%, more preferably ≧0.7% by weight.

It is preferred, furthermore, for the fraction of polyhydroxyalkanoate in the biobased plastic to be 5-99.5%, more preferably 20-99.3%.

The present invention further provides a method for producing the biobased plastics of the invention, whereby at least one polyhydroxyalkanoate is mixed with at least 0.5% by weight, preferably 0.7% to 4% by weight, more preferably 1%-2.5% by weight, very preferably 1% to 2.0% by weight, of at least one oligomeric and/or polymeric, aromatic and/or araliphatic carbodiimide in a mixing assembly.

Mixing assemblies for the purposes of the invention are, for example, an extruder or compounder.

The present invention additionally provides for the use of the biobased plastics of the invention in long-lived applications, such as, for example, electronics, automotive, construction, transport, household, e.g. as bath utensils, or office requisites, or for “severe conditions” applications, such as under the sterile conditions in medicine, for example.

The scope of the invention encompasses all of the radical definitions, indices, parameters and elucidations that are general or given in preference ranges, and are listed above and below, in conjunction with one another, hence including between the respective ranges and preference ranges, in any desired combination.

The examples below serve to elucidate the invention, without having any limiting effect.

### WORKING EXAMPLES

Chemicals Used:

CDI I: a sterically hindered aromatic carbodiimide (Stabaxol® I LF) having an NCN content of at least 10.0%, from Rhein Chemie Rheinau GmbH.

CDI II: a sterically hindered aromatic oligomeric carbodiimide (Stabaxol® P) having an NCN content of 13.5%, from Rhein Chemie Rheinau GmbH.

CDI III: a sterically hindered aromatic polymeric carbodiimide (Stabaxol® P 400) having an NCN content of 13.5%, from Rhein Chemie Rheinau GmbH.

Carbodilite® LA-1 (H12MDI-PCDI): a polymeric aliphatic carbodiimide having an NCN content of 15.8%, from Nisshinbo.

Polyhydroxyalkanoate (PHA): Mirel P 1003

Polylactic acid (PLA): Ingeo 2002 D from NatureWorks

Apparatus Used:

The carbodiimides were incorporated into the polyhydroxyalkanoate using a ZSK 25 twin-screw laboratory extruder from Werner und Pfleiderer.

The amounts of additive used and the nature of the additive used are apparent from Tables 1 to 4.

The standard F3 test specimens were produced on an Arburg Allrounder 320 S 150-500 injection-molding machine.

For the hydrolysis test on polyhydroxyalkanoate (PHA), the standard F3 test specimens were stored in water at a temperature of 85° C. and, after different time units, a tensile test was carried out in order to ascertain the tensile strength. The hydrolysis protection period describes the lifetime of the test specimens: after how many days under test conditions the tensile strength has taken on a value of less than 5 MPa.

For the hydrolysis tests of the comparative experiments with polylactic acid (PLA), the standard F3 test specimens were stored in water at a temperature of 65° C. and, after different time units, a tensile test was carried out in order to ascertain the tensile strength.

The melt volume rate (MVR) was measured using a model MI 4 instrument from Göttfert. The residual moisture content of the polymer pellets is not more than 100 ppm.

Test conditions for PHA (samples 1-16): measurement temperature 175° C., test weight 2.16 kg, melting time: 5 minutes.

Test conditions for PLA (samples 17-24): measurement temperature 200° C., test weight 2.16 kg, melting time: 5 minutes.

TABLE 1
Inventive samples and their test results (amounts in % by weight):

| | Additives | Hydrolysis protection | MVR |
|---|---|---|---|
| Sample | used in PHA | period [d] | [ccm/10 min] |
| 1 | 1.0% CDI II | 14 | 9.4 |
| 2 | 1.5% CDI II | 29 | 10.8 |
| 3 | 2.0% CDI II | 31 | 12.5 |
| 4 | 1.0% CDI III | 18 | 9.5 |
| 5 | 1.5% CDI III | 30 | 10.7 |
| 6 | 2.0% CDI III | 33 | 11.1 |

TABLE 2
Comparative example, unadditized PHA:

| | | Hydrolysis protection | MVR |
|---|---|---|---|
| Sample | Base mixture of | period [d] | [ccm/10 min] |
| 7 | PHA direct from the | 6 | 7.4 |
| | container | | |
| 8 | PHA 1 x extruded | 6 | 24.9 |

TABLE 3
Comparative examples (amounts in % by weight):

| | Additives | Hydrolysis protection | MVR |
|---|---|---|---|
| Sample | used in PHA | period [d] | [ccm/10 min] |
| 9 | 0.5% CDI I | 6 | 12.9 |
| 10 | 1.0% CDI I | 14 | 10.8 |
| 11 | 1.5% CDI I | 19 | 13.5 |
| 12 | 2.0% CDI I | 29 | 15.4 |
| 13 | 0.5% CDI II | 7 | 10.4 |
| 14 | 0.5% CDI III | 6 | 11.2 |
| 15 | 0.5% H12MDI-PCDI | 7 | 22.7 |
| 16 | 1.0% H12MDI-PCDI | 11 | 10.9 |

TABLE 4
Comparative examples (amounts in % by weight):

| | Additives | Hydrolysis protection | MVR |
|---|---|---|---|
| | used in PLA | period [d] | [ccm/10 min] |
| 17 | 0.5% CDI I | 5 | 4.2 |
| 18 | 1.0% CDI I | 16 | 4.5 |
| 19 | 1.5% CDI I | 37 | 4.6 |
| 20 | 0.5% CDI II | 6 | 2.9 |
| 21 | 1.0% CDI II | 8 | 3.1 |
| 22 | 1.5% CDI II | 11 | 3.2 |

TABLE 5
Comparative example, unadditized PLA:

| | | Hydrolysis protection | MVR |
|---|---|---|---|
| | Base mixture of | period [d] | [ccm/10 min] |
| 23 | PLA direct from the | 5 | 3.4 |
| | container | | |
| 24 | PLA 1 x extruded | 5 | 4.2 |

The inventive mixtures 1 to 6 are notable for high inhibition of hydrolysis and for excellent MVR scores. Accordingly they are a significant improvement over the mixtures of PLA with carbodiimides, for which always only either the hydrolysis stability or the MVR score is improved, but never both.

From comparative examples 17-22 it is apparent, moreover, that the effects of the carbodiimides in PLA and PHA are, surprisingly, distinctly different. In PLA, monomeric carbodiimides (CDI I) exhibit the best hydrolysis protection period, while polymeric carbodiimides (CDI II), by comparison therewith, have lesser activity in PLA. In PHA, in contrast, polymeric carbodiimides (CDI II and CDI III) show a better hydrolysis protection period than monomeric carbodiimides (CDI I).

What is claimed is:

1. Biobased plastics comprising a combination of at least one polyhydroxyalkanoate and >0.5% by weight of at least one oligomeric and/or polymeric aromatic and/or araliphatic carbodiimide.

2. The biobased plastics as claimed in claim 1, characterized in that the fraction of the oligomeric and/or polymeric carbodiimides is at least 0.7-4% by weight,

3. The biobased plastics as claimed in claims 1 to 2, characterized in that the polymeric and/or oligomeric aromatic and/or araliphatic carbodiimide is a compound of the general formula (II),
R′—(—N═C═N—R′″—)ₘ—R″ (II),
in which
R′″ is an aromatic and/or araliphatic radical and for m>1, R′″ within the molecule is identical or different and in the case of different combinations, each of the aforementioned radicals may be combined as desired with one another,
R′″ in the case of an aromatic or an araliphatic radical may carry no or, in at least one ortho-position to the aromatic carbon atom that carries the carbodiimide group, may carry aliphatic and/or cycloaliphatic substituents having at least 2 carbon atoms, which may also carry heteroatoms,
R′″=C₁-C₁₈-alkyl, C₅-C₁₈-cycloalkyl, aryl, C₇-C₁₈-aralkyl, —R—COOR¹, −R—OR¹, —R—N(R¹)₂, —R—SR¹, —R—OH, —R—NH₂, —R—NHR¹, —R-epoxy, —R—NCO, —R—NHCONHR¹, —R—NHCONR¹R² or —R—NHCOOR³, where R=aromatic, aliphatic, cycloaliphatic and/or araliphatic radical,
R″═H, —N═C═N-aryl, —N═C═N-alkyl, —N═C═N-cycloalkyl, —N═C═N-aralkyl, —NCO, —NHCONHR¹, —NHCONR¹R², —NHCOOR³, —NHCOS—R¹, —COOR¹, —OR¹, —N(R¹)₂, —SR¹, —OH, —NH₂, —NHR¹,
and in R′ and R″, independently of one another, R¹ and R² are identical or different and are a C₁-C₂₀-alkyl, C₃-C₂₀-cycloalkyl-, aryl, C₇-C₁₈-aralkyl radical, oligo-/polyethylene glycols and/or oligo-/propylene glycols, and R³ has one of the definitions of R¹ or is a polyester radical or a polyamide radical, and m corresponds to an integer from 2 to 5000; in the case of oligomeric carbodiimides, m corresponds to an integer from 2 to 5, and in the case of polymeric carbodiimides, m corresponds to an integer of >5,
and/or at least one carbodiimide of the formula (III)
R′—[—(—N═C═N—Y—)ₚ—(—B—)_{q}—]ₒ—X (III),
where
Y=arylene, C₇-C₁₈-aralkylene,
p=an integer from 1 to 500, preferably 1 to 100,
B=—NH—CO—NH—Z—, —NH—COO—Z—, —NH—COS—Z—,
q=an integer from 1 to 500, preferably 1 to 100,
o=an integer from 1 to 500, preferably 1 to 100, and
either p or o must be >1,
X═H, —OH, —SH, —NH₂, —OR¹, —N(R¹)₂, —SR¹, —NHR¹, NR¹R², —OCO—NH—R′, NHCO—, —NH—R′, —S—CO—NH—R′,
R′═C₁-C₁₈-alkyl, C₅-C₁₈-cycloalkyl, aryl, C₇-C₁₈-aralkyl, —R′″—NH—COS—R¹, —R′″—COOR¹, —R′″—N(R¹)₂, —R′″—SR¹, —R′″—OH, —R′″—NH₂, —R′″—NHR¹, −R′″-epoxy, —R′″—NCO, —R′″—NHCONHR¹, ≧R′″—NHCONR¹R² or —R′″—NH—COOR³, where
R¹ and R² are identical or different and are a C₁-C₂₀-alkyl, C₃-C₂₀-cycloalkyl, aryl, or C₇-C₁₈-arylkyl radical, or are oligo-/polyethylene glycols and/or oligo-/propylene glycols, and R³ has one of the definitions of R¹ or is a polyester radical or a polyamide radical, Z═Y, polyesters, polyethers, polyamides, and R′″ is an aromatic and/or araliphatic radical.

4. The biobased plastics as claimed in one or more of claims 1 to 3, characterized in that the oligomeric and/or polymeric carbodiimides used are preferably aromatic compounds.

5. The biobased plastics as claimed in one or more of claims 1 to 4, characterized in that the polymeric and/or oligomeric carbodiimide comprises compounds of the formula (II) in which R′″ corresponds to 1,3-substituted 2,4,6-triisopropylphenyl and/or 1,3-bis(1-methyl-1-isocyanatoethyl)benzene and/or tetramethylxylylene derivatives and/or 2,4-substituted tolylene and/or 2,6-substituted tolylene and/or mixtures of 2,4- or 2,6-substituted tolylene.

6. The biobased plastics as claimed in one or more of claims 1 to 5, characterized in that the polyhydroxyalkanoate is a compound of the formula (1) 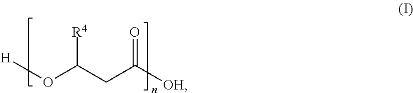
in which n>10 and R⁴ corresponds to a C₁-C₁₄-alkyl radical.

7. A method for producing the biobased plastics as claimed in one or more of claims 1 to 6, characterized in that at least one polyhydroxyalkanoate is mixed with at least 0.5% by weight of at least one oligomeric and/or polymeric aromatic and/or araliphatic carbodiimide in a mixing assembly.

8. The use of the biobased plastics as claimed in one or more of claims 1 to 7 in long-lived applications in electronics, automotive, construction, transport, household, office requisites or in “severe conditions” applications.
